(19) United States
(12) Patent Application Publication
(10) Pub. No.: US 2007/0133896 A1
(43) Pub. Date: Jun. 14, 2007

(54) Ringing artifact reduction for compressed video applications

(75) Inventors: Lilla Boroczky, Mount Kisco, NY (US); Yibin Yang, Pine Brook, NJ (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/598,184

(22) PCT Filed: Feb. 27, 2004
(86) PCT No.: PCT/IB05/50664

§ 371 Date: Aug. 21, 2006

Related U.S. Application Data
(60) Provisional application No. 60/548,673, filed on Feb. 27, 2004.

(51) Int. Cl. G06K 9/40

(52) U.S. Cl. 382/268

(57) ABSTRACT

A method of reducing ringing artifacts in a compressed digital video signal includes decoding the coded video signal; determining plurality of metric values in a region near at least one pixel, wherein the metric values are greater than a particular value; and applying a deringing method to substantially reduce ringing artifacts near the pixel. An apparatus for selectively deringing a compressed digital video signal includes a decoding device, a metric calculation device and a metric-controlled deringing device, wherein the deringing device reduces ringing artifacts in certain regions of a video frame based on data from the metric calculation device. In accordance with another example embodiment, the metric-controlled deringing device updates the metric data of the frame based on the deringing.

The present application claims priority under 35 U.S.C. § 120 and 35 USC § 365(c) to International Patent Application serial number IB2003/0057 filed on Dec. 4, 2003 and entitled “A Unified Metric For Digital Video Processing (UMDVP),” to Boroczky, et al; and to International Patent Application Number IB2003/0055 filed Nov. 28, 2003 and entitled “System and Method for Joint Video Enhancement and Artifact Reduction for Coded Digital Video”, to Boroczky, et al. These applications are assigned to the present assignee. The disclosures of these applications are specifically incorporated herein by reference.

Moving Picture Expert Group (MPEG) video compression technology facilitates many current and emerging video products (e.g., DVD players, high definition television decoders, and video conferencing) by requiring less storage and less bandwidth. This compression comes at the expense of a reduction in picture quality due to the introduction of artifacts. It is well known that such lossy compression technology (MPEG-1, MPEG-2, MPEG-4, H.26x, etc.) can cause the introduction of coding artifacts that decrease picture quality of the decoded video.

As is well-known, video compression technology may be in a variety of formats, such as those listed above. Moreover, encoded video signals may be received by a variety of applications to include liquid crystal on silicon (LCOS) and other LCD devices. LCOS devices have the capability of providing relatively high resolution video images. However, compression artifacts that are not readily discernable in many display technologies may be significant in the LCOS display due to its intrinsic sharpness. Therefore, there exist drawbacks in certain known artifact reduction methods and apparati.

In block-based coding techniques the most frequent artifacts are blockiness and ringing and numerous methods have been developed that address reduction of these various artifacts. A common objective of these methods is to reduce the artifacts without decreasing any other desirable feature of the scene content (e.g., image sharpness and fine detail). Moreover, the traditional sharpness enhancement methods perform sub-optimally for encoded digital video, often enhancing coding artifacts already present.

Usually, in both de-blocking and de-ringing methods, the first step is detecting the artifacts, followed by applying artifact reduction methods to reduce the artifacts. If the artifact detection step is incorrect, the resulting picture quality can be worse than before artifact reduction. Therefore, it is useful to be able to reliably detect and substantially reduce or eliminate the coding artifacts of a coded video bitstream.

In accordance with a example embodiment, a method of reducing ringing artifacts in a compressed digital video signal includes decoding the coded video signal; determining plurality of metric values in a region near at least one pixel, wherein the metric values are greater than a particular value; and applying a deringing method to substantially reduce ringing artifacts near the pixel.

In accordance with another example embodiment, a method of reducing ringing artifacts in a compressed digital video signal includes, calculating an average of a metric from a plurality of metric values in selected regions of a frame; and applying a deringing method if the average metric in one of the selected regions is under a threshold.

In accordance with another example embodiment, an apparatus for selectively deringing a compressed digital video signal includes a decoding device, a metric calculation device and a metric-controlled deringing device, wherein the deringing device reduces ringing artifacts in certain regions of a video frame based on data from the metric calculation device. In accordance with another example embodiment, the metric-controlled deringing device updates the metric data of the frame based on the deringing.

The invention is best understood from the following detailed description when read with the accompanying drawing figures.

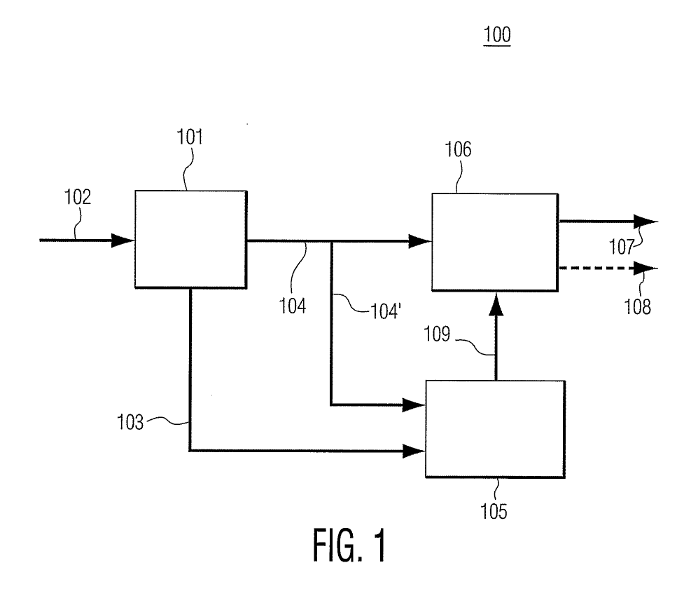

FIG. 1 is a block diagram of an apparatus for controlled deringing of compressed digital video signals in accordance with an example embodiment.

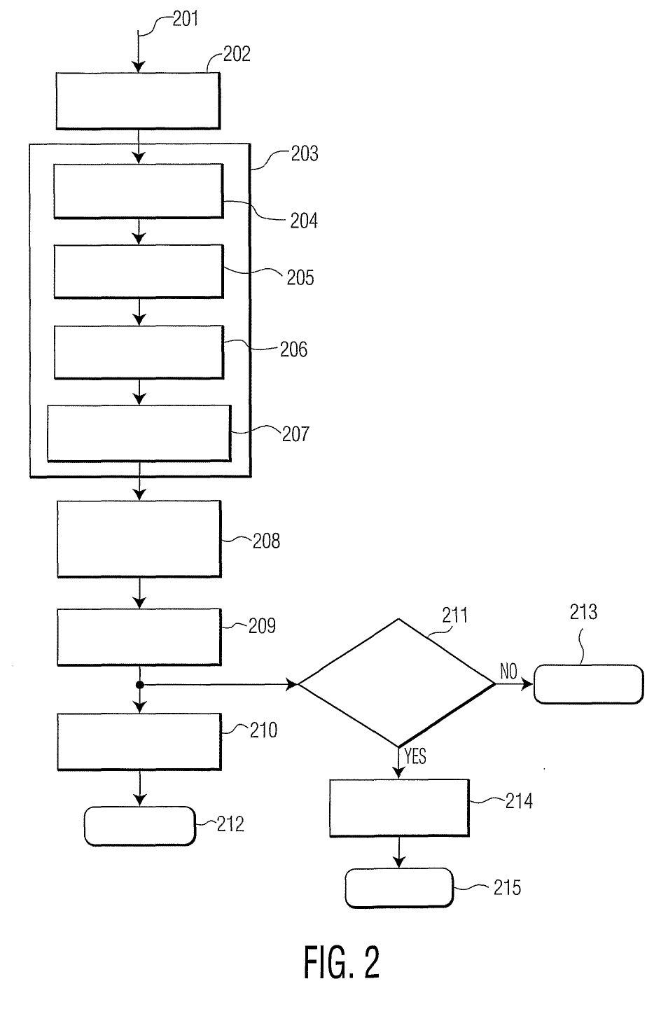

FIG. 2 is a flowchart of an illustrative method for controlled deringing of compressed digital video signals in accordance with an example embodiment.

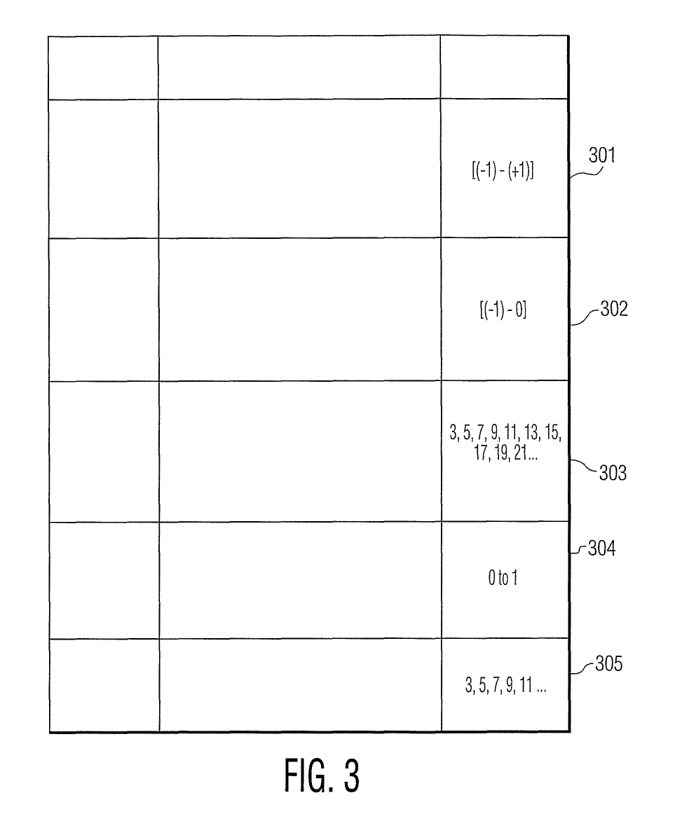

FIG. 3 is a tabular representation of relevant programmable parameters in a Unified Metric for Digital Video Processing (UMDVP)-controlled deringing method in accordance with an example embodiment.

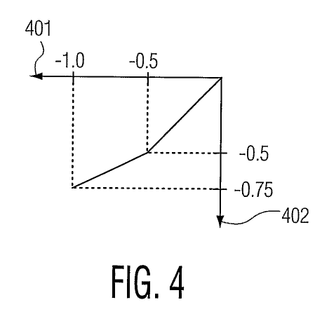

FIG. 4 is a graphical representation showing the reduction of extremely negative UMDVP values in accordance with an example embodiment.

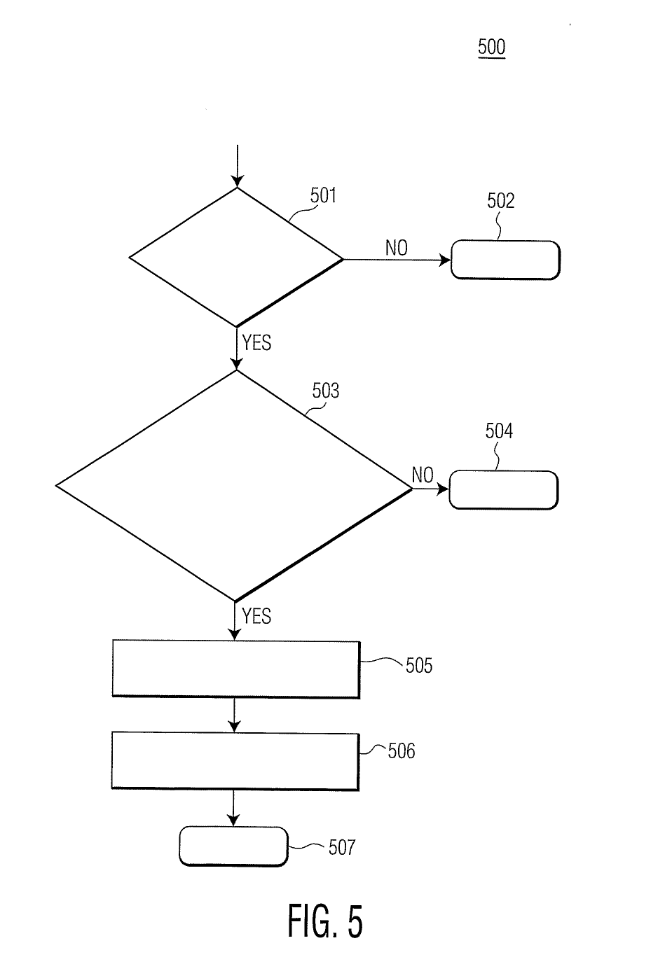

FIG. 5 is a flowchart of an illustrative method of deringing the luminance component of a compressed digital video signal in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the present invention. Such methods and apparati and methods are clearly within the contemplation of the inventors in carrying out the example embodiments. Wherever possible, like numerals refer to like features throughout.

FIG. 1 is a schematic block diagram of an apparatus 100 for reducing artifacts in compressed digital video signals in accordance with an example embodiment. It is noted that, unless otherwise described, the modules/devices of the example embodiments of FIG. 1 include hardware, or software or both that perform functions described herein. This hardware and/or software are within the purview of one of ordinary skill in the art, and thus are not described in detail so as to not obscure the description of the example embodiments.

A decoder 101 module decodes an input video signal 102, by one or more of a variety of known techniques. A decoded video signal 104 is output to a metric controlled artifact reduction device 106, while a portion is tapped as signal 104 and input to a metric calculation device 105.

Coding information 103 is also output by the decoder 101 and is input into the metric calculation device 105. As will become more clear as the present description continues, this coding information 103 is used by the metric calculation device to promulgate artifact reduction and to update metric information of the processed video signal. As such, after certain methods of example embodiments are applied to the coding information, the metric 109 is input to the metric controlled artifact reduction device 106. This metric controlled artifact reduction device 106 then applies certain methods of example embodiments to reduce artifacts. The artifact reduction device 106 then outputs a post-processed video signal 107, which provides an improved image from the perspective of image quality.

The device 106 outputs an updated metric for the signal, fostering the better image quality. It is noted that the various devices of the apparatus 100 may be electronic devices readily apparent to one having ordinary skill in the art, and are thus not described in further detail. Furthermore, it is noted that the example embodiments described herein primarily focus on the deringing of ringing artifacts in the input compressed digital video signal 102. However, it is noted that other functions may be applied. For example, artifact reduction and video enhancement methods and apparati as described in co-pending application (serial number IB2003/0055) referenced previously. As such, the methods and apparati of this commonly-owned application are specifically incorporated herein by reference.

In the example embodiments described herein, the compressed digital video signals are in the MPEG-2 format, and the metric is the UMDVP metric described in the co-pending application IB/20030057 referenced previously, as well as discussed in greater detail below. As such, the decoder module 101 is an MPEG-2 decoder, the signal input to the decoder 101 is an MPEG-2 signal and the output from the decoder and from the artifact reduction device are in MPEG-2 format. Moreover, the coding information 103 is illustratively MPEG-2 coding information, and the output from the metric calculation is UMDVP data. Finally, in the present application, the metric calculation device 105 may be referred to as a UMDVP calculation device 105; the decoder 101 may be referred to as the MPEG-2 decoder; and the metric controlled artifact device 106 may be referred to as a UMDVP-controlled deringing device.

However, it is noted that the referenced formats and metrics are merely illustrative of the example embodiments. To wit, other formats and metrics, to include other known digital video compression formats and metrics, as well as the progeny of known video compression formats and metrics may be used in keeping with the example embodiments described herein.

Prior to describing in detail the methods and devices for providing selective deringing to the MPEG-2 signals, the UMDVP metric is discussed.

In keeping with the example embodiments, the UMDVP calculation device 105 the UMDVP metric for each pixel or group of pixels in a manner described in the priority application. From the coding information 103 and decoded video of 104, this UMDVP metric is calculated and reflects the local picture quality of the MPEG-2 encoded video. The UMDVP is determined based on such block-based coding information as the quantization scale, number of bits spent to code a block, and picture type (I, P or B). Such coding information is obtained from the MPEG-2 bitstream for little computational cost. The coding information is sent by the decoder to the metric calculation module. The UMDVP calculation device 105 can adapt the UMDVP to the local scene contents using local spatial features such as local variance.

The values of the UMDVP metric can be positive or negative. The lower the UMDVP value, the more likely the pixel is to have coding artifacts. In general, high positive UMDVP values indicate that the pixels should be sharpened and excluded from artifact reduction. In an example embodiment, the UMDVP controlled artifact reduction device 106 receives the UMDVP metric 109 and uses this metric 109 to reduce selected ringing artifacts in a manner described herein.

While the UMDVP metric 109 can indicate whether or to what degree to apply artifact reduction to a pixel, this metric does not provide a means to distinguish between different coding artifacts, such as blockiness or ringing. Thus, it is up to the UMDVP artifact reduction device 106 to determine how to use the UMDVP metric to achieve a higher performance. For example, the value of the UMDVP metric 109 determines how “aggressively” artifact reduction (or sharpness enhancement, if such a function is included in the device 106) should be performed. The details of the deringing methods using the UMDVP data are described in further details below.

Many types of artifacts can be introduced by lossy encoding of a video signal and can be reduced using corresponding methods during post-processing by the apparatus 100. A metric, e.g., UMDVP, can be used to control when, where and how much post-processing is accomplished by these methods.

Two types of artifacts that commonly occur in coded video streams are blockiness and ringing. Blockiness manifests itself as visible discontinuities at block boundaries due to the independent coding of adjacent blocks. Ringing is most evident along high contrast edges in areas of generally smooth texture and appears as ripples extending outwards from the edge. Ringing is caused by abrupt truncation of high frequency DCT components, which play significant roles in the representation of an edge.

While blockiness and remedial de-blocking have been widely studied and many de-blocking methods have been developed, ringing has drawn less attention. In particular, satisfactory deringing methods for large high-contrast high-resolution displays are not present in known apparati and those that due exist are either based on simple spatial filtering resulting in a compromised picture quality, or their computational complexity prevents implementation in real-time. However, ringing artifacts can be even visible at higher bit rates and are exaggerated on such displays as High-definition monitors and LCOS-based displays, and are thus may degrade the quality of the image.

The present example embodiments may beneficially reduce the ringing artifacts be methods and apparati described presently.

In keeping with example embodiments, an illustrative deringing method for the artifact reduction module is described to illustrate how an appropriate metric can be used to control a post-processing method. This deringing method is based on adaptive spatial filtering and employs a metric, such as UMDVP, calculated by the UMDVP calculation device 105, to determine the location of the filtering (detection), the size of the filter, and which pixels are included or excluded in the filter window. Further, based on the value of the metric, the deringing method adaptively determines how much a filtered pixel can differ from its original values, thus providing a control over the displacement that depends on the strength of the original compression.

Ringing artifacts that can occur in the chrominance components due to color sub-sampling may spread through the entire macroblock. This problem is substantially remedied by applying chrominance filtering in a beneficial manner.

Ringing can also occur in the luminance components, and are particularly problematic at strong edges of the image. These artifacts are substantially reduced by applying luminance filtering by applying the methods of example embodiments.

In either case the illustrative methods described presently use the UMDVP to determine where and to what degree to apply adaptive filtering to the signal in order to reduce or eliminate the ringing artifacts. Finally, the methods of the example embodiments determine which pixels are included in and which pixels are excluded from the filtering window.

FIG. 2 is a flowchart of a method 200 of deringing a compressed digital video signal in accordance with an example embodiment. In conjunction with the flowchart of FIG. 2, it is useful to review the table 300, which includes relevant parameters and illustrative ranges of each. It is noted that rows 301 through 305 may be used in keeping with the example embodiments. It is further noted that some of the rows may not explicitly discussed, but are nonetheless pertinent to certain aspects of the embodiments.

The method 200 is illustratively implemented in the UMDVP-controlled artifact reduction device 106 of FIG. 1. As in FIG. 1, the input 201 is a UMDVP metric from the UMDVP calculation device 105 and the decoded video from the decoder 101. At step 202, the average UMDVP value per frame is calculated for each frame, excluding the UMDVP ‘zero’ values. This average per frame enables the distinguishing between low quality sources having a lower average UMDVP metric, and high quality source having a higher UMDVP metric. The frames with higher values are less likely to have deringing techniques applied, as these are high-quality video signals. This parameter and its illustrative values are described in row 301 of FIG. 3. Thus, the averaging sequence of step 202 allows results in the switching to the off state of the deringing function for video sequences (frames), which are encoded in high quality video substantially without coding artifacts, or which may be comprised of high-quality encoded video and low-quality encoded video; but which have an average that is above a threshold of acceptable quality.

The UMDVP values may include uncertainties, as a variety of assumptions are often made during the initial calculation of these values. In order to address these uncertainties, the UMDVP values from the input 101 are pre-processed in step 203.

The first substep in step 203 is the reduction of extreme negative values in substep 204 to reduce temporal inconsistency in the video sequence after processing by the UMDVP controlled deringing device. To wit, and as shown in FIG. 4, the input UMDVP values 401 having greater negative magnitudes are reduced in a manner shown so that after substep 204, the UMDVP output 402 values are reduced in magnitude.

The next step in the preprocessing of the UMDVP is the elimination of isolated positive UMDVP values at 205. These data are indicative of high quality signals, and do not require any deringing through filtering.

At substep 206 UMDVP map sequence is pre-filtered. Because the UNDVP map has some blocky structures in the area of the negative values, low-pass filtering is applied at this step to smooth out the unwanted structure. This may be done via a 5×5 averaging filter or similar known device. It is noted that this is merely illustrative of the example embodiments, and other filters to include non-symmetric filters may be used in this and other filtering steps of the example embodiments. In the last substep 207 of the pre-processing step 203, isolated UMDVP values of ‘0’ and negative values are set to ‘1’ to remove these isolated values. This is done to prevent isolated deringing in areas such as edges. Further details of this sequence are described in the application referenced previously (serial number IB 2003/0055).

In step 208, the number of large UMDVP values around a particular pixel is determined. In keeping with an example embodiment, this pixel may be in proximity to a strong edge of the image, where a number of relatively large positive UMDVP values may be found. Pixels near these strong edges may have significant ringing artifacts, and through their identification in step 208, these may be significantly reduced or eliminated in subsequent processing. Stated differently, the relatively high density of high UMDVP values (localized values) is indicative of a strong edge of the image. After the detection, the deringing methods of the example embodiments may be employed.

In accordance with an example embodiment, at step 208, the artifacts in the region of the strong edges are localized for deringing by counting the number of large positive UMDVP values in a window around a particular pixel that is to be deringed. This large UMDVP value, which is illustratively greater than approximately 0.5, is compared to a threshold that is related to the size of the window. The window-size parameter is further described in connection with row 303 of FIG. 3, while the edge pixel threshold parameter is further described in connection with row 304. It is noted that the size of the window is a useful parameter for it determines the extent to which there is filtering around the edge.

At step 209, the maximum displacement is calculated based on the UMDVP values to determine how much the filtered pixel values can differ from the original UMDVP value of the pixel. Further details are found in the application referenced previously (serial number IB2003/0055).

After completion of step 209, the deringing of the luminance component is carried in step 210 and the deringing of the chrominance component is carried out in step 211. Each of these is effected via respective sub-methods described presently.

FIG. 5 is a deringing method 500 for the luminance values of the compressed digital video. The input UMDVP values, the UMDVP values and the filter functions are input at a first step 501. A filtering sequence is carried out on a particular pixel if the number of large UMDVP values calculated for this pixel is greater than a predetermined number of pixels in the window (e.g., ⅔ of the pixels in the window). If this condition is not met, the luminance deringing is completed at step 502 and thus at step 212.

Next, at step 503, the average UMDVP value of the frame, UMDVP_avrg, is used in the exemplary method. Deringing is carried out with the UMDVP values of ‘0’ only if the frame has a relative low only if the frame has a relatively low average UMDVP value with respect to a threshold UMDVP_avrg_thr, that is the frame most likely has coding artifacts. This threshold is described at row 301 of FIG. 3. Illustratively, the threshold may be set to 0.2. If this is not the case, the sequence is finished at step 504.

Alternatively, at step 503, if the UMDVP_avrg is larger than this threshold, deringing is carried out only at pixels which have negative UMDVP values smaller than UMDVP-neg_thr (illustratively (-0.25)). This negative threshold is described at row 302 of FIG. 2. If this condition is not met, the sequence is terminated at step 504.

If the conditions of step 503 outlined above are met, the method continues at step 505 with low-pass filtering of the pixel. Illustratively, a filter window of 3×3 pixels may be used, although this is merely illustrative.

Finally, at step 506, the original luminance value is replaced by the filtered value based on maximum displacement, which is a function of the UMDVP value as described in the referenced application. The sequence terminates at step 507, which is commensurate with step 212.

At step the deringing in a pixel by low-pass filtering. Illustratively, an averaging filter (e.g. 3×3), but exclude pixels whose UMDVP values are positive and pixels which luminance values differ more than 10 percent from the pixel to be filtered. The filter was an averaging filter. Finally the original luminance value is replaced by the filtered one based on the maximum difference, which is also function of the UMDVP.

Returning to FIG. 2, the deringing of the chrominance is optionally carried out. If this is foregone, the sequence is completed at step 213 and the post-processed video signal 107 is transmitted with updated UMDVP values 108. If deringing is carried out, the chrominance deringing described in the above referenced application (serial number IB2003/0055) may be effected.

In accordance with an example embodiment, the UMDVP-controlled deringing method updates the original UMDVP map to reflect the quality of the video after deringing was applied. The updated UMDVP 108 is defined as:

$$UMDVP\_upd ( i , j ) = \{ \begin{matrix}UMDVP ( i , j ) + 1.3 & if & Y\_der ( i , j ) \neq Y ( i , j ) \\ UMDVP ( i , j ) & & otherwise\end{matrix}$$

where UMDVP_upd(i,j) is the updated UMDVP at pixel (i,j); UMDVP(i,j) is the original UMDVP at (i,j); Y_der(i,j) is the pixel luminance value after post-processing by deringing and Y(i,j) is the original luminance value of the pixel. The updated UMDVP allows more aggressive sharpness enhancement as its values become relatively positive values in pixels where deringing has changed the luminance values. It is noted that other methods to adaptively update of the UMDVP is also possible, however the one derived via the above method has been exceedingly beneficial.

In view of this disclosure it is noted that the various methods and devices described herein can be implemented in either software or hardware or a combination of the two to achieve a desired performance level. Further, the various methods and parameters are included by way of example only and not in any limiting sense. Therefore, the embodiments described are illustrative and are useful in reducing ringing artifacts, particularly around strong edges, as well as to provide an updated metric value, and are not intended to be limitive to the example embodiments. In view of this disclosure, those skilled in the art can implement the various example devices and methods in determining their own processing of the decoded digital video, while remaining within the scope of the appended claims.

1. A method of reducing ringing artifacts in a compressed digital video signal, the method comprising:
decoding the coded video signal;
determining plurality of metric values in a region near at least one pixel, wherein the metric
values are greater than a particular value; and
applying a deringing method to substantially reduce ringing artifacts near the pixel.

2. A method as recited in claim 1, wherein the pixel is near or at an edge of an image of a frame.

3. A method as recited in claim 2, wherein the plurality of metric values is for pixels near a strong edge of the image.

4. A method as recited in claim 1, wherein the metric values are UMDVP values.

5. A method as recited in claim 4, wherein artifacts are localized for deringing by counting the number of UMDVP values greater than the particular value in a window around a pixel that is to be deringed.

6. A method as recited in claim 5, wherein the number of UMDVP values greater than the particular value is compared to a threshold value that is proportional to a size of the window.

7. A method as recited in claim 6, wherein the method is repeated for a plurality of regions in the frame.

8. A method as recited in claim 6, further comprising deringing a luminance component of the decoded video signal.

9. A method as recited in claim 6, further comprising deringing a chrominance component of the decoded video signal.

10. A method as recited in claim 8, further comprising, after the deringing, updating metric data of a post-processed signal.

11. A method as recited in claim 9, further comprising, after the deringing, updating metric data of a post-processed signal.

12. A method of reducing ringing artifacts in a compressed digital video signal, the method comprising:
determining an average of a metric from a plurality of metric values in selected regions of a frame; and
applying a deringing method if the average metric in one of the selected regions is above a threshold.

13. A method as recited in claim 12, further comprising decoding the digital video signal, before determining the average.

14. A method as recited in claim 12, further comprising deringing a luminance component of the decoded video signal.

15. A method as recited in claim 12, further comprising deringing a chrominance component of the decoded video signal.

16. An apparatus for selectively deringing a compressed digital video signal, comprising:
a decoding module;
a metric calculation module; and
a metric-controlled deringing module, wherein the deringing module reduces ringing
artifacts in certain regions of a video frame based on data from the metric calculation device.

17. An apparatus as recited in claim 16, wherein the metric-controlled deringing module updates metric data of the frame based on the deringing.

18. A method as recited in claim 16, wherein the metric is a UMDVP metric.

19. An apparatus as recited in claim 16, wherein the deringing module substantially reduces or eliminates ringing artifacts in selected regions of a frame.

20. An apparatus as recited in claim 16, wherein the deringing module substantially reduces or eliminates ringing artifacts in a frame.
